(19) United States
(12) Patent Application Publication
(10) Pub. No.: US 2025/0219928 A1
(43) Pub. Date: Jul. 3, 2025

(54) Intra-Domain Source Address Validation Using IGPs

(71) Applicant: HUAWEI TECHNOLOGIES CO., LTD., Shenzhen (CN)

(72) Inventors: Yingzhen Qu, Santa Clara, CA (US); Alvaro Enrique Retana, Santa Clara, CA (US)

(21) Appl. No.: 19/013,902

(22) Filed: Jan. 8, 2025

Related U.S. Application Data
(63) Continuation of application No. PCT/US2023/027163, filed on Jul. 7, 2023.
(60) Provisional application No. 63/359,592, filed on Jul. 8, 2022.

(51) Int. Cl. H04L 45/12; H04L 45/00; H04L 45/745

(52) U.S. Cl. CPC H04L 45/123; H04L 45/72; H04L 45/745

(57) ABSTRACT

A method implemented by a network node in an interior gateway protocol (IGP) domain. The method includes receiving a link state announcement from one or more other network nodes in the IGP domain, performing shortest path first (SPF) based on the link state announcement received from the one or more other network nodes to determine a path through the domain, building a forwarding information base (FIB) table based on the SPF, determining that the path through the domain is symmetrical, and duplicating the FIB to generate a source address validation (SAV) table.

### CROSS-REFERENCE TO RELATED APPLICATIONS

This is a continuation of International Patent Application No. PCT/US2023/027163 filed Jul. 7, 2023, which claims the benefit of U.S. Provisional Patent Application No. 63/359,592 filed Jul. 8, 2022, which is hereby incorporated by reference.

### TECHNICAL FIELD

The present disclosure is generally related to communications using the Internet Protocol (IP) and, more specifically, to source address validation.

### BACKGROUND

The IP is the network layer communications protocol in the Internet protocol suite for relaying datagrams across network boundaries. Its routing function enables internetworking, and essentially establishes the Internet.

IP has the task of delivering packets from the source host to the destination host solely based on the IP addresses in the packet headers. For this purpose, IP defines packet structures that encapsulate the data to be delivered. IP also defines addressing methods that are used to label the datagram with source and destination information.

Source address validation (SAV) is a standard formalized in Internet Engineering Task Force (IETF) Request for Comments (RFC) 2827 entitled “Network Ingress Filtering: Defeating Denial of Service Attacks which employ IP Source Address Spoofing” by P. Ferguson, et al., published May 2000. The standard is aimed at discarding packets with spoofed source IP addresses. The absence of SAV is known as a root cause of reflection distributed denial-of-service (DDoS) attacks.

### SUMMARY

The disclosed aspects/embodiments provide techniques for validating the source of a packet. By using the disclosed techniques for SAV, packets with invalid or suspicious source Internet protocol (IP) addresses are prevented from entering or leaving a network. This can reduce the risk of source address spoofing and associated security threats such as distributed denial-of-service (DDoS) attacks, etc.

A first aspect relates to a method implemented by a network node in an interior gateway protocol (IGP) domain, comprising: receiving link state announcements from one or more other network nodes in the IGP domain; performing a shortest path first (SPF) calculation based on the link state announcement received from the one or more other network nodes to determine one or more paths from the network node through the domain; building a forwarding information base (FIB) table based on the SPF calculation; determining that the paths through the domain are symmetrical; and duplicating the FIB table to generate a source address validation (SAV) table.

Optionally, in any of the preceding aspects, another implementation of the aspect provides that the SAV table is built based on only IGP and not any additional protocol.

Optionally, in any of the preceding aspects, another implementation of the aspect provides that the FIB table includes a destination prefix column and an outgoing port column, and wherein the SAV table includes a source prefix column and an incoming port column.

Optionally, in any of the preceding aspects, another implementation of the aspect provides that values in the destination prefix column are identical to values in the source prefix column, and wherein values in the outgoing port column are identical to values in the incoming port column.

Optionally, in any of the preceding aspects, another implementation of the aspect provides receiving a packet identifying a source address and a destination address; verifying that the packet was received on an incoming port corresponding to the source address using the SAV table; and transmitting the packet from an outgoing port corresponding to the destination address using the FIB table.

Optionally, in any of the preceding aspects, another implementation of the aspect provides receiving a packet identifying a source address and a destination address; determining that the packet was not received on an incoming port corresponding to the source address using the SAV table; and dropping the packet or transmitting the packet somewhere for further inspection.

A second aspect relates to a method implemented by a network node in an interior gateway protocol (IGP) domain, comprising: receiving a link state announcement from one or more other network nodes in the IGP domain; performing a first shortest path first (SPF) based on the link state announcement received from the one or more other network nodes to determine one or more paths from the network node through the domain; building a forwarding information base (FIB) table based on the first SPF calculation; determining that one of the paths through the domain includes an asymmetrical link; performing a second SPF calculation using a reverse metric of the asymmetrical link; and generating a source address validation (SAV) table based on the first SPF calculation and the second SPF calculation.

Optionally, in any of the preceding aspects, another implementation of the aspect provides that link metrics, including the reverse link metric, are stored in a link state database (LSDB) of the network node.

Optionally, in any of the preceding aspects, another implementation of the aspect provides that comparing the link metrics in both forward and reverse directions during the first SPF calculation to determine the path through the domain includes the asymmetric link.

Optionally, in any of the preceding aspects, another implementation of the aspect provides that comparing the link metrics in both forward and reverse directions when receiving the link state announcement from the one or more other network nodes to determine the path through the domain includes the asymmetric link.

Optionally, in any of the preceding aspects, another implementation of the aspect provides that receiving a message from the one or more other network nodes that a link connected to the one or more other network nodes is asymmetric.

A third aspect relates to a method implemented by a network node in an interior gateway protocol (IGP) domain, comprising: receiving link state announcements from one or more other network nodes in the IGP domain, wherein a link state announcement received from a first network node of the one or more network nodes specifies static routing or a routing policy for routing packets from the first network node to the network node; performing a first shortest path first (SPF) calculation based on the link state announcement received from the one or more other network nodes to determine one or more paths from the network node through the domain; building a forwarding information base (FIB) table based on the first SPF calculation; performing a second SPF calculation using a value of zero for a metric between the first network node and a second network node in accordance with the static routing or the routing policy; and generating a source address validation (SAV) table based on the FIB and the second SPF calculation.

Optionally, in any of the preceding aspects, another implementation of the aspect provides determining that one of the paths through the domain includes an asymmetrical link, wherein the second SPF calculation is performed using: a reverse metric of the asymmetrical link; and the value of zero for the metric between the first network node and the second network node in accordance with the static routing or the routing policy.

Optionally, in any of the preceding aspects, another implementation of the aspect provides that the second network node is a next hop of the first network node.

Optionally, in any of the preceding aspects, another implementation of the aspect provides that the SAV table includes a destination port corresponding to a source prefix.

Optionally, in any of the preceding aspects, another implementation of the aspect provides that the link state announcement received from the first network node includes a type length value (TLV) field, wherein a TLV in the TLV field includes a flags field and a next hop field, wherein a value in the flags field is zero, and wherein a value in the next hop field identifies the second network node.

Optionally, in any of the preceding aspects, another implementation of the aspect provides that the link state announcement is an Open Shortest Path First version 2 (OSPFv2) Router Information Opaque link state announcement or an Open Shortest Path First version 3 (OSPFv3) Router Information link state announcement.

Optionally, in any of the preceding aspects, another implementation of the aspect provides that the link state announcement received from the first network node includes a type length value (TLV) field, wherein a TLV in the TLV field includes an address prefix field and a sub-type length value (TLV) field, wherein the address prefix field identifies a destination prefix, wherein a sub-TLV in the sub-TLV field includes a flags field, a source prefix field, and a next hop field, wherein a value in the flags field is one, wherein a value in the source prefix field identifies a source, and wherein a value in the next hop field identifies the second network node.

Optionally, in any of the preceding aspects, another implementation of the aspect provides that the link state announcement is an Extended Prefix Opaque link state announcement, and wherein the TLV is an Extended Prefix TLV or a Router-Link TLV.

Optionally, in any of the preceding aspects, another implementation of the aspect provides that the link state announcement received from the first network node includes a type length value (TLV) field, wherein a TLV in the TLV field includes a sub-TLV field, wherein a sub-TLV in the sub-TLV field includes a flags field and a next hop field, wherein a value in the flags field is zero, and wherein a value in the next hop field identifies the second network node.

Optionally, in any of the preceding aspects, another implementation of the aspect provides that the TLV is an IS-IS Router Capability TLV.

Optionally, in any of the preceding aspects, another implementation of the aspect provides that the link state announcement received from the first network node includes a type length value (TLV) field, wherein a TLV in the TLV field includes a sub-TLV field, wherein a sub-TLV in the sub-TLV field includes a flags field, a source prefix field, and a next hop field, wherein a value in the flags field is zero, wherein a value in the source prefix field identifies a source, and wherein a value in the next hop field identifies the second network node.

Optionally, in any of the preceding aspects, another implementation of the aspect provides that the TLV is an Extended Internet Protocol version 4 (IPv4) Reachability TLV, a Multi-Topology IPv4 Reachability TLV, an Internet Protocol version 6 (IPv6) Reachability TLV, or a Multi-Topology IPv6 Reachability TLV.

A fourth aspect relates to a network node in an interior gateway protocol (IGP) domain, comprising: a memory configured to store instructions; and one or more processors coupled to the memory and configured to execute the instructions to cause the network node to perform the method in any of the disclosed embodiments.

A fifth aspect relates to a non-transitory computer readable medium comprising a computer program product for use by a network node, the computer program product comprising computer executable instructions stored on the non-transitory computer readable medium that, when executed by one or more processors, cause the network node to execute the method in any of the disclosed aspects.

A sixth aspect relates to a network node in an interior gateway protocol (IGP) domain, comprising means for performing the method in any of the disclosed aspects.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a network topology including an Interior Gateway Protocol (IGP) domain.

FIG. 2 is a schematic diagram of a network topology including the IGP domain.

FIG. 3 is an illustration of a distributed source address validation (DSAV) workflow.

FIG. 4 is an illustration of a SAV table built for a symmetrical path according to an embodiment of the disclosure.

FIG. 5 is an illustration of a SAV table built when the path through the domain includes an asymmetrical link according to an embodiment of the disclosure.

FIG. 6 is an illustration of a SAV table built when there is static routing or a routing policy for routing packets through the domain according to an embodiment of the disclosure.

FIG. 7 is an Open Shortest Path First version 2 (OSPFv2) Router Information Opaque Link State Announcement (LSA) according to an embodiment of the disclosure.

FIG. 8 is an Open Shortest Path First version 3 (OSPFv3) Router Information LSA according to an embodiment of the disclosure.

FIG. 9 is a Type Length Value (TLV) for router level encoding according to an embodiment of the disclosure.

FIG. 10 is an OSPFv2 Extended Prefix TLV according to an embodiment of the disclosure.

FIG. 11 is a sub-TLV for prefix level encoding according to an embodiment of the disclosure.

FIG. 12 is a schematic diagram of an Intermediate System-Intermediate System (IS-IS) sub-TLV for router level encoding according to an embodiment of the disclosure.

FIG. 13 is a schematic diagram of an IS-IS sub-TLV for prefix level encoding according to an embodiment of the disclosure.

FIG. 14 is a method implemented by a network node in the IGP domain according to an embodiment of the disclosure.

FIG. 15 is a method implemented by a network node in the IGP domain according to an embodiment of the disclosure.

FIG. 16 is a method implemented by a network node in the IGP domain according to an embodiment of the disclosure.

FIG. 17 is a schematic diagram of a network apparatus according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

An IP packet (or simply, a packet) has a source address and a destination address. As noted above, IP source address spoofing is the practice of maliciously sending packets with a forged or incorrect source address.

Mutually Agreed Norms for Routing Security (MANRS) is a global initiative that helps reduce the most common routing threats. MANRS provides a set of best practices based on existing norms for network operators to improve the security of the global Internet routing system. One of the best practices relates to anti-spoofing, and has the goal of enabling source address validation (SAV) and implementing anti-spoofing to prevent packets with incorrect source IP addresses from entering and leaving the network.

SAV is a problem with a long history of attention by the Internet Engineering Task Force (IETF). Numerous IETF documents describe anti-spoofing techniques. Best Current Practice (BCP) 38/Internet Engineering Task Force (IETF) Request for Comments (RFC) 2827 entitled “Network Ingress Filtering: Defeating Denial of Service Attached which employ IP Source Address Spoofing” by P. Ferguson, et al., published May 2000, discloses techniques used to block IP packets that have the source IP address forged at the edge of the Internet from entering the Internet.

IETF RFC 6959 entitled “Source Address Validation Improvement (SAVI) Threat Scope” by D. McPherson, et al., published May 2013, discloses techniques used for source address spoof-based threats and existing solutions.

IETF RFC 2267 entitled “Network Ingress Filtering: Defeating Denial of Service Attached which employ IP Source Address Spoofing” by P. Ferguson, et al., published January 1998, which along with RFC 2827, disclose techniques used for ingress filtering and access control list (ACL)-based SAV. One problem with these techniques is the need for manual configuration of network devices.

IETF RFC 3704 entitled “Ingress Filtering for Multihomed Networks” by F. Baker, et al., published March 2004, discloses strict unicast reverse path forwarding (strict-uRPF) and feasible-uRPF. One problem with these techniques is that they improperly block packets when there is asymmetric routing, and they improperly permit packets to be routed in some circumstances.

IETF RFC 6620 entitled “FCFS SAVI: First-Come, First-Served Source Address Validation Improvement for Locally Assigned IPV6 Addresses” by E. Nordmark, et al., published May 2012, IETF RFC 7030 entitled “Enrollment over Secure Transport” by M. Pritikin, et al., published October 2013, IETF RFC 7039 entitled “Source Address Validation Improvement (SAVI) Framework” by J. Wu, et al., published October 2013, IETF RFC 7219 entitled “SEcure Neighbor Discovery (SEND) Source Address Validation Improvement (SAVI)” by M. Bagnulo, et al., published May 2014, IETF RFC 7513 entitled “Source Address Validation Improvement (SAVI) Framework” by J. Wu, et al., published October 2013, IETF RFC 8074 entitled “Source Address Validation Improvement (SAVI) Solution for DHCP” by J. Bi, et al., published May 2015, and IETF RFC 8074 entitled “Source Address Validation Improvement (SAVI) for Mixed Address Assignment Methods Scenario” by J. Bi, et al., published February 2017, along with RFC 6959, disclose techniques for source address validation improvement. One problem with these techniques is how they deal with host-level SAV in access networks (enterprise networks).

IETF RFC 6620 entitled “FCFS SAVI: First-Come, First-Served Source Address Validation Improvement for Locally Assigned IPV6 Addresses” by E. Nordmark, et al., published May 2012, discloses enhanced feasible path (EFP), which mitigates problems associated with strict-uRPF/feasible-uRPF in some cases.

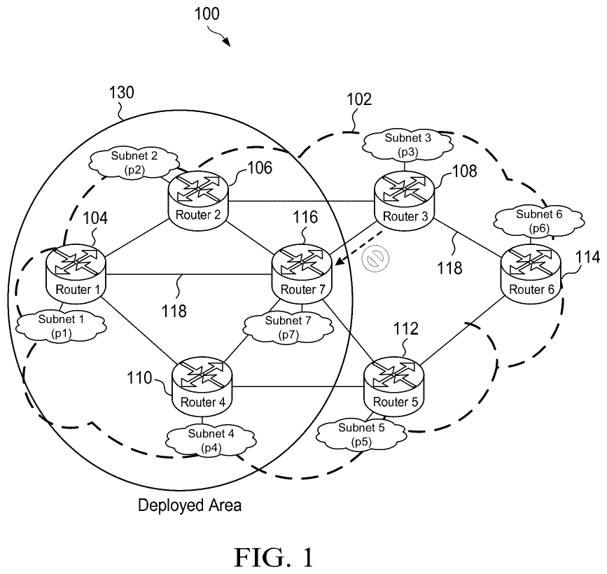

FIG. 1 is a schematic diagram of a network topology 100 including an Interior Gateway Protocol (IGP) domain 102. The IGP domain 102 comprises a plurality of network nodes 104, 106, 108, 110, 112, 114, and 116. While seven network nodes 104-116 are shown in the IDP domain 102, more or fewer network nodes may be included in practical applications. In an embodiment, the network nodes 104-116 comprise a router, a switch, or other network device capable of routing packets through the IGP domain 102.

Some of the network nodes, e.g., network nodes 104, 114, are disposed at an edge of the IGP domain 102. The network nodes 104, 114 receiving packets from outside the IGP domain 102 may be referred to as ingress network nodes. The network nodes 104, 114, transmitting packets out of the IGP domain 102 may be referred to as egress network nodes. Depending on the direction of multicast packet traffic, either of the network nodes 104, 114 may function as an ingress network node or an egress network node. While not shown, the network nodes disposed at an edge of the IGP domain 102 may be coupled to nodes disposed outside the IGP domain 102. The network nodes that are not disposed at an edge of the IGP domain 102, e.g., network nodes 108, 110, 116, may be referred to intermediate network nodes, internal network nodes, or transit nodes.

The network nodes 104-116 are coupled to each other via links 118. The links 118 may be wired, wireless, or some combination thereof. As discussed more fully below, each of the links 118 have a cost based, for example, on the bandwidth of the length. The links 118 also couple each of the network nodes 104-116 to another subnetwork. The subnetworks in FIG. 1 are labeled Subnet 1 (p1), Subnet 2 (p2), Subnet 2 (p2), Subnet 3 (p3), Subnet 4 (p4), Subnet 5 (p5), Subnet 6 (p6), and Subnet 7 (p7).

FIG. 1 illustrates that applying strict-uRPF only at a subnet port in intra-domain SAV results in an improper permit problem. When all of the network devices 104-116 make the same deployment of, for example, a strict-uRPF policy, then there is no problem. However, when only some of the network devices, e.g., the network devices 104, 106, 110, and 116 within the deployed area 130, apply the strict-uRPF policy at their subnet port spoofing may still occur. For example, when network device 108 (a.k.a., Router 3) sends packets to network device 116 by spoofing the source addresses of Subnet 1 associated with network device 104, by spoofing the source addresses of Subnet 2 associated with network device 106, or by spoofing the source addresses of Subnet 4 associated with network device 110 (as shown by the dashed arrow), the network device 116 will improperly permit the packets. Thus, subnets outside the deployed area 130 are able to spoof addresses of subnets within the deployed area 130.

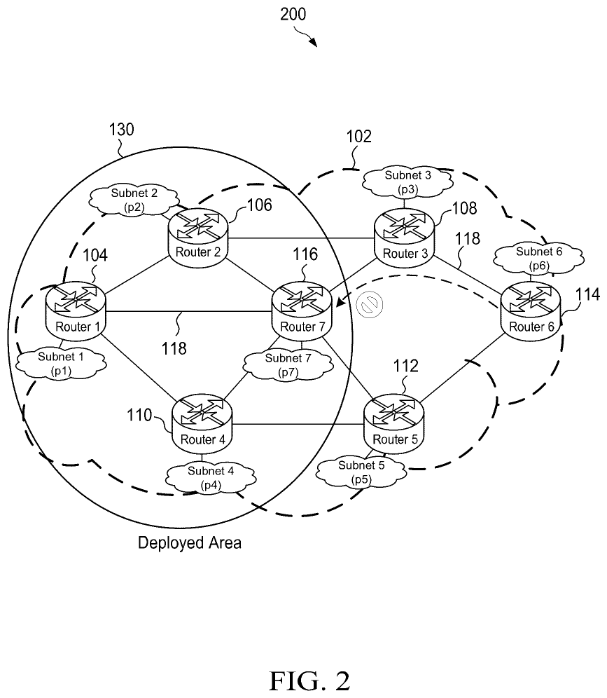

FIG. 2 is a schematic diagram of a network topology 200 including an IGP domain 102. The IGP domain 102 comprises a plurality of network nodes 104, 106, 108, 110, 112, 114, and 116. While seven network nodes 104-116 are shown in the IDP domain 102, more or fewer network nodes may be included in practical applications. In an embodiment, the network nodes 104-116 comprise a router, a switch, or other network device capable of routing packets through the IGP domain 102.

The network nodes 104-116 are coupled to each other via links 118. The links 118 may be wired, wireless, or some combination thereof. As discussed more fully below, each of the links 118 have a cost based, for example, on the bandwidth of the length. The links 118 also couple each of the network nodes 104-116 to another subnetwork. The subnetworks in FIG. 2 are labeled Subnet 1 (p1), Subnet 2 (p2), Subnet 2 (p2), Subnet 3 (p3), Subnet 4 (p4), Subnet 5 (p5), Subnet 6 (p6), and Subnet 7 (p7). As shown, some of the network devices e.g., the network devices 104, 106, 110, and 116, are disposed within the deployed area 130.

In FIG. 2, the network device 116 applies strict-uRPF at all subnet ports in intra-domain SAV. However, this results in an improper block problem when there is asymmetric routing. Asymmetric routing occurs when the path between network nodes is not the same in both directions. For example, assume the routing path from the network node 116 to the network node 114 is network node 116→network node 112→network node 114, and the routing path from the network node 114 to the network node 116 is network node 114→network node 108→network network node 116. In such cases, when the network device 114 sends valid packets to the network device 116, the network device 116 will improperly block the packets (as shown by the dashed arrow).

When all of the network devices 104-116 make the same deployment of, for example, a strict-uRPF policy, then there is no problem. However, when only some of the network devices, e.g., the network devices 104, 106, 110, and 116 within the deployed area 130, apply the strict-uRPF policy at their subnet port spoofing may still occur. For example, when network device 108 (a.k.a., Router 3) sends packets to network device 116 by spoofing the source addresses of Subnet 1 associated with network device 104, by spoofing the source addresses of Subnet 2 associated with network device 106, or by spoofing the source addresses of Subnet 4 associated with network device 110 (as shown by the dashed arrow), the network device 116 will improperly permit the packets. Thus, subnets outside the deployed area 130 are able to spoof addresses of subnets within the deployed area 130.

One of the existing solutions that attempts to address the spoofing issue is known as distributed source address validation (DSAV). DASV is discussed in detail in the IETF document entitled “Distributed Source Address Validation (DSAV) Framework” (draft-li-dsav-framework-01) by D. Li, et al., published Jan. 11, 2022. In DASV, a source address is validated using SAV tables generated by a distributed control-plane protocol. That is, the DSAV framework depends on a distributed control-plane protocol to generate an accurate SAV table instead of using uRPF. DSAV provides periodic or triggered updates (when a routing information changes) to distribute SAV rules to network nodes.

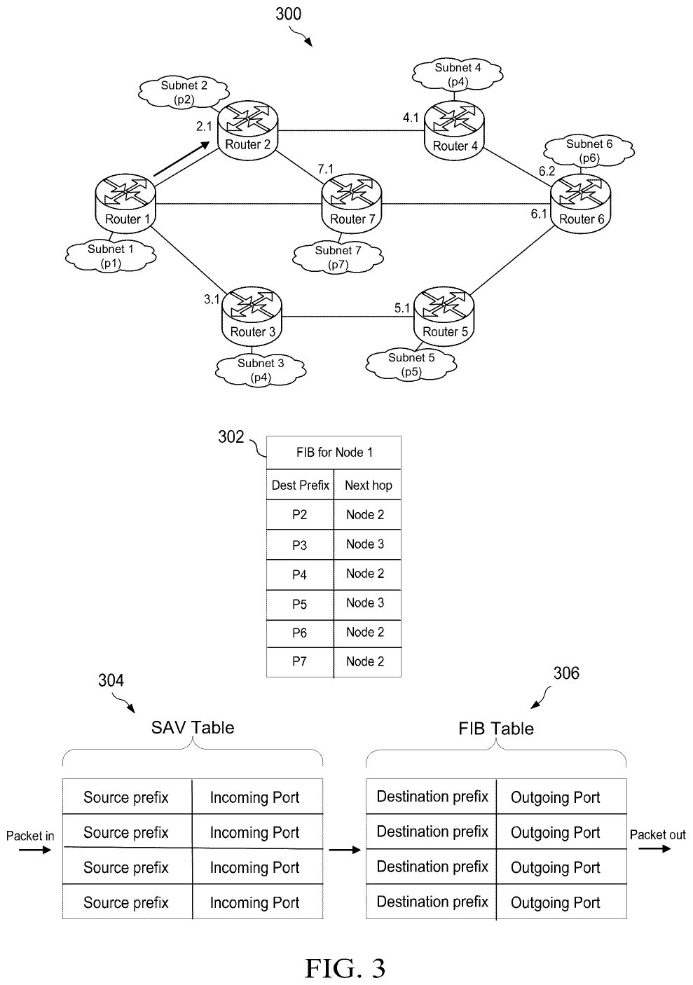

FIG. 3 is an illustration 300 of a distributed source address validation (DSAV) workflow. In the illustrated example, various network nodes, labeled Router 1 through Router 7, are coupled together via links. Each of the network nodes is coupled to a corresponding subnetwork, labeled Subnet 1 through Subnet 7. The network nodes, links, and subnetworks depicted in FIG. 3 are similar to the network nodes, links, and subnets depicted in FIGS. 1-2. For the sake of brevity, a detailed description of these elements is not repeated herein.

The process of prefix notification is described from the perspective of Router 1 and Subnet 1 (p1). As shown, p1 is the source prefix of Router 1. Therefore, Router 1 conducts message origination. Router 1 stores or has access to a forwarding information base (FIB) table 302. The FIB table 302 includes a destination prefix and corresponding next hop for each other subnetwork associated with a network node in the network. The FIB table 302 indicates that for the destination prefixes p2, p4, p6, and p7, the next hop is Router 2 (i.e., Node 2). Therefore, Router 1 generates a notification message and transmits the notification message to Router 2. The notification message includes a source prefix (e.g., p1) and a propagation scope (e.g., p2, p4, p6, p7).

Still referring to FIG. 3, Router 1 uses the DSAV process to build a SAV table 304. The SAV table 304 is then used by Router 1 to validate the source of incoming or received packets. For example, Router 1 checks to see whether a packet received at an incoming port listed in the SAV table 304 has the corresponding prefix listed in the SAV table 304. If not, Router 1 determines the packet may have a spoofed address and drops the packet. If so, Router 1 transmits the packet from the outgoing port in the FIB table 306 (which is a generic representation of FIB table 302) corresponding to the destination prefix in the packet.

While the DSAV framework depicted in FIG. 3 may address some spoofing problems, there are still drawbacks. For example the DSAV framework uses an entirely new protocol to generate the SAV table 304. In addition, the DSAV framework makes achieving full deployment difficult, and adds a significant amount of control plane traffic and states. Moreover, the DSAV framework relies on reactive convergence. That is, when a network failure occurs (e.g., a network node or link fails), forwarding can start working only after SAV converges.

Disclosed herein are techniques for validating the source of a packet. The techniques use existing Interior Gateway Protocols (e.g., Open Shortest Path First (OSPF) and Intermediate System-Intermediate System (IS-IS)) and information already available in a link state database (LSDB), in some cases with a simple extension or an additional shortest path first (SPF) calculation, to achieve source address validation (SAV). By implementing SAV using the disclosed techniques, packets with an incorrect source Internet Protocol (IP) addresses are prevented from entering and leaving a network.

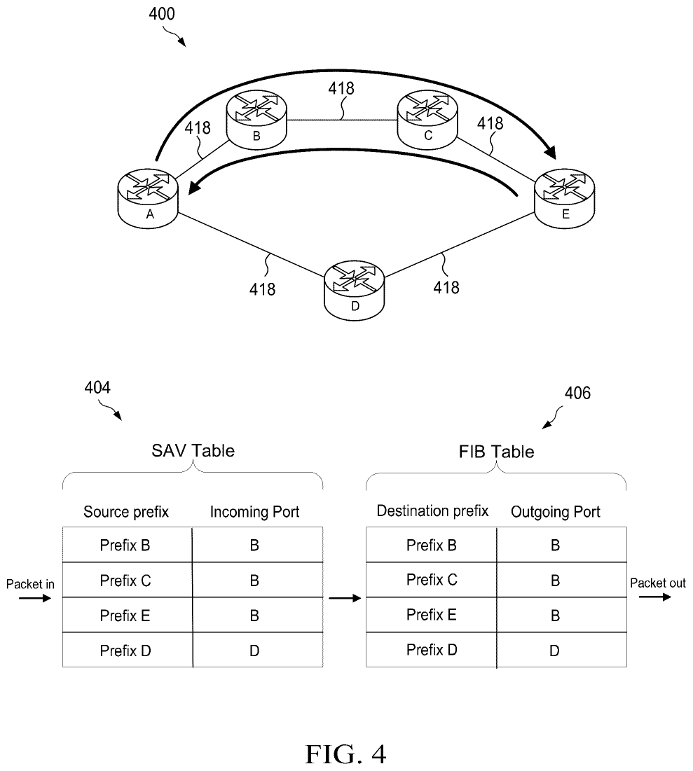

FIG. 4 is an illustration 400 of a SAV table 404 built for a symmetrical path (represented by the arrows) according to an embodiment of the disclosure. In the illustrated example, various network nodes, labeled Router A, B, C, D, and E, are coupled together via links 418. The network nodes and links depicted in FIG. 4 are similar to the network nodes and links depicted in FIGS. 1-2. For the sake of brevity, a detailed description of these elements is not repeated herein.

In FIG. 4, the network nodes A, B, C, D, and E are disposed in an Interior Gateway Protocol (IGP) domain. Thus, the network nodes (e.g., routers) utilize open shortest path first (OSPF) or Intermediate System-Intermediate System (IS-IS) to route IP packets (or simply, packets) in the IGP domain of an IP network.

OSPF uses a link state routing (LSR) algorithm and falls into the group of interior gateway protocols (IGPs) operating within a single autonomous system (AS). OSPF gathers link state information from available routers and constructs a topology map of the network. The topology is presented as a routing table to the Internet Layer for routing packets by their destination IP address. OSPF supports Internet Protocol Version 4 (IPv4) and Internet Protocol Version 6 (IPv6) networks. OSPF version 2 (OSPFv2) is defined for IPV4 by RFC 2328 entitled “OSPF Version 2” by J. Moy, et al., published April 1998. OSPF version 3 (OSPFv3) is defined for IPV6 in RFC 5340 entitled “OSPF Version 3” by R. Coltun, et al., published July 2008. OSPF is widely used in large enterprise networks.

Intermediate System to Intermediate System (IS-IS, or ISIS) is a link-state routing protocol. IS-IS operates by flooding link state information throughout a network of routers. Each IS-IS router independently builds a database of the network's topology, thereby aggregating the flooded network information. Like the OSPF protocol, IS-IS computes the best path through the network. Packets (or datagrams) are then forwarded, based on the computed ideal path, through the network to the destination.

Intermediate System to Intermediate System (IS-IS, or ISIS) is another LSR routing protocol designed to move information efficiently within a computer network, a group of physically connected computers, or similar devices. IS-IS accomplishes this by determining the best route for data through a packet switching network. The IS-IS protocol is defined in RFC 1142 entitled “OSI IS-IS Intra-domain Routing Protocol” by D. Oran, published February 1990. IS-IS is common in large service provider networks.

As shown in FIG. 4, the path through the domain from Router A to Router E is symmetrical (represented by the arrows). The path is symmetrical when the links 418 between the routers have the same value in both directions and/or there are no routing policies in place. For example, the path is symmetrical when the links 418 on the path of Router A→Router B→Router C→Router E have the same cost as links 418 on the path of Router E→Router C→Router B→Router E. For example, the path is also symmetrical when there are no routing policies in place that supersede or take precedence over the path calculated by OSPF.

An example of how to build the SAV table 404 from the perspective of Router A when a path through the IGP domain is symmetrical is provided. Notably, the same procedure may be similarly used by other routers in the domain to build their own SAV table.

To begin, Router A receives a link state announcement from one or more of the other network nodes in the IGP domain. That is, Router A receives a link state announcement from Router B, Router C, Router D, and/or Router E. In an embodiment, the link state announcement is a link state update (LSU) corresponding to the OSPF protocol. In an embodiment, the link state announcement is a protocol data unit (PDU), known as a link state PDU (LSP), corresponding to the IS-IS protocol.

Router A performs a shortest path first (SPF) calculation based on the link state announcement received from the other network nodes to determine a path though the domain. Thereafter, Router A builds forwarding information base (FIB) table 406 based on the SPF calculation. In an embodiment, the FIB 406 includes a destination prefix column and an outgoing port column. As shown in FIG. 4, entries in the destination prefix column correspond to one of the routers in the IGP domain. For example, the destination prefix column includes Prefix B corresponding to Router B, Prefix C corresponding to Router C, Prefix E corresponding to Router E, and Prefix D corresponding to Router D. The outgoing port identified for each prefix indicates the port used by Router A to transmit a packet having the corresponding prefix. For example, a packet having Prefix C as the destination prefix (or destination) is transmitted from outgoing port B.

Router A determines that the path through the domain is symmetrical. In an embodiment, Router A makes this determination based on the SPF calculation. For example, during the SPF calculation Router A discovers that the links 418 along the path have the same cost in both directions (i.e., forward and reverse directions, or downstream and upstream directions). That is, Router A determines that the cost of transmitting the packet from Router A→Router B→Router C→Router E is the same as the cost of transmitting the packet from Router E→Router C→Router B→Router E.

In an embodiment, Router A determines that the path through the domain is symmetrical after building the FIB table 406. In an embodiment, Router A determines that the path through the domain is symmetrical before building the FIB table 406. In an embodiment, Router A determines that the path through the domain is symmetrical at or about the same time as building the FIB table 406.

Next, Router A duplicates the FIB table 406 to generate the SAV table 404. In doing so, the entries in the destination prefix column of the FIB table 406 are copied or otherwise input into the source prefix column of the SAV table 404. In addition, the entries in the outgoing port column of the FIB table 406 are copied or otherwise input into the incoming port column of the SAV table 404. As such, values in the destination prefix column of the FIB table 406 are identical to values in the source prefix column of the SAV table 404, and values in the outgoing port column of the FIB table 406 are identical to values in the incoming port column of the SAV table 404 as shown in FIG. 4.

Unlike DSAV, which uses a new or additional protocol to establish a SAV table, the process depicted in FIG. 4 is accomplished using the existing IGP framework. That is, the SAV table 404 in FIG. 4 can be built using the existing OSPF or IS-IS scheme, which is less complicated and cumbersome than DSAV.

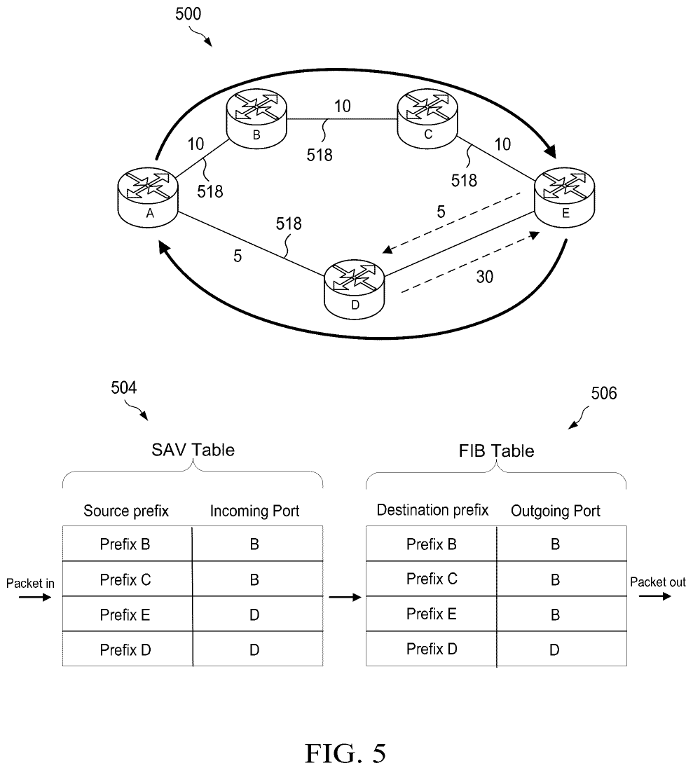

FIG. 5 is an illustration 500 of a SAV table 504 built when the path through the domain includes an asymmetrical link (represented by the dashed arrows) according to an embodiment of the disclosure. In the illustrated example, various network nodes, labeled Router A, B, C, D, and E, are coupled together via links 518. The network nodes and links depicted in FIG. 5 are similar to the network nodes and links depicted in FIGS. 1-2. For the sake of brevity, a detailed description of these elements is not repeated herein.

In FIG. 5, the network nodes A, B, C, D, and E are disposed in an IGP domain. Thus, the network nodes (e.g., routers) utilize OSPF or IS-IS to route IP packets (or simply, packets) in the IGP domain of an IP network.

In FIG. 5, each of the links 518 has a metric. For example, the link 518 between Router A and Router B has a metric of 10, the link 518 between Router B and Router C has a metric of 10, and the link 518 between Router C and Router E has a metric of 10. The link 518 between Router A and Router D has a metric of 5. The link 518 between Router D and Router E has a metric in a direction from Router D to Router E, which is a forward metric, and has a metric in another direction from Router E to Router D, which is a reverse metric). As shown in FIG. 5, the forward metric between Router D and Router E is 30 and the reverse metric between Router E and Router D is 5.

An example of how to build the SAV table 504 from the perspective of Router A when a path through the IGP domain is asymmetrical is provided. Notably, the same procedure may be similarly used by other routers in the domain to build their own SAV table.

To begin, Router A receives a link state announcement from one or more of the other network nodes in the IGP domain. That is, Router A receives a link state announcement from Router B, Router C, Router D, and/or Router E. In an embodiment, the link state announcement is an LSU corresponding to the OSPF protocol or an LSP corresponding to the IS-IS protocol.

Router A performs an SPF calculation based on the link state announcement received from the other network nodes to determine a path though the domain. When the SPF calculation is performed by Router A, the path from Router A to Router E is determined to be Router A→Router B→Router C→Router E (as shown by the top arrow), and the path from Router E to Router A is determined to be Router E→Router D→Router A (as shown by the bottom arrow). Because the path from Router A to Router E is different than the path from Router E to Router A, routing is asymmetrical.

Thereafter, Router A builds FIB table 506 based on the SPF calculation. In an embodiment, the FIB 506 includes a destination prefix column and an outgoing port column. As shown in FIG. 5, entries in the destination prefix column correspond to one of the routers in the IGP domain. For example, the destination prefix column includes Prefix B corresponding to Router B, Prefix C corresponding to Router C, Prefix E corresponding to Router E, and Prefix D corresponding to Router D. The outgoing port identified for each prefix indicates the port used by Router A to transmit a packet having the corresponding prefix. For example, a packet having Prefix C as the destination prefix is transmitted from outgoing port B.

Router A determines that the path through the domain includes an asymmetrical link (e.g., the link 518 between Router D and Router E). In an embodiment, Router A compares the metrics of every link in both directions during the SPF calculation. For example, during the SPF calculation Router A discovers that the link 518 between Router D and Router E has different metrics in different directions. That is, Router A determines that the cost of transmitting the packet from Router D→Router E is different than the cost of transmitting the packet from Router E→Router D. If any asymmetric links are detected, Router A performs an additional SPF calculation (which will be more fully explained below) to account for the asymmetric links. In an embodiment, metrics are stored in a link state database (LSDB) of a network node (e.g., Router A).

In an embodiment, Router A receives a link state announcement with a flag set to indicate that the additional SPF calculation is needed to account for the asymmetric links. In an embodiment, Router A determines whether any of the links 518 is asymmetrical and, if so, signals other network nodes in the IGP domain accordingly. In an embodiment, Router A determines that the domain includes an asymmetrical link based on the SPF calculation, the link state announcement, or some combination thereof.

In the illustrated example, the total cost of transmitting a packet from Router E→Router D→Router A is 10 (i.e., 5+5) and the total cost of transmitting the packet from Router E→Router C→Router B→Router A is 30 (i.e., 10+10+10). As such, Router A determines that the best path for a packet to be transmitted from Router E to Router A is from Router E→Router D→Router A. Because the path through the IGP domain from Router A to Router E is different than the path from Router E to Router A, asymmetric routing occurs.

In an embodiment, Router A determines that the path through the domain is asymmetrical after building the FIB table 506. In an embodiment, Router A determines that the path through the domain is asymmetrical before building the FIB table 506. In an embodiment,

Router A determines that the path through the domain is asymmetrical at or about the same time as building the FIB table 506.

Because the link 518 between Router D and Router E has different metrics in different directions, Router A performs the additional SPF calculation using the reverse metric of the link 518. That is, Router A performs a second SPF calculation using the metric 5 instead of the metric 30 as shown in FIG. 5. The second SPF may be referred to an another SPF calculation, an additional SPF calculation, a subsequent SPF calculation, or something similar.

Next, Router A generates the SAV table 504 based on the FIB table 506 and the second SPF calculation. In an embodiment, Router A duplicates the FIB table 506, but updates entries to account for asymmetrical links, to generate the SAV table 504. For example, Router A updates the SAV table 504 to indicate that packets having a source prefix of Prefix E will be received from Router D instead of from Router B due to the asymmetric routing.

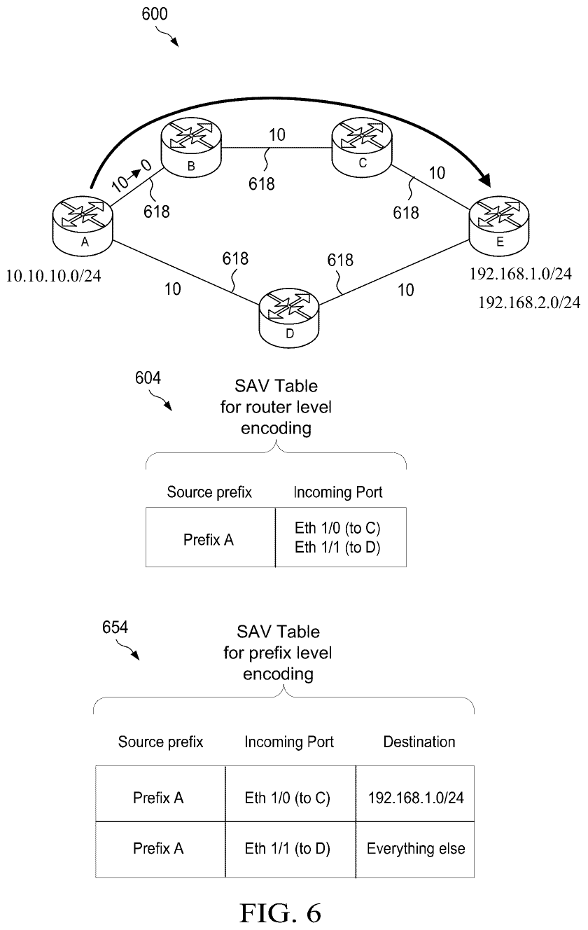

FIG. 6 is an illustration 600 of a SAV table 604 built when there is static routing or a routing policy for routing packets through the domain according to an embodiment of the disclosure. In the illustrated example, various network nodes, labeled Router A, B, C, D, and E, are coupled together via links 618. The network nodes and links depicted in FIG. 6 are similar to the network nodes and links depicted in FIGS. 1-2. For the sake of brevity, a detailed description of these elements is not repeated herein.

In FIG. 6, the network nodes A, B, C, D, and E are disposed in an IGP domain. Thus, the network nodes (e.g., routers) utilize OSPF or IS-IS to route IP packets (or simply, packets) in the IGP domain of an IP network.

Static routing, or a routing policy, is a form of routing that occurs when a router utilizes manually-configured routing entries or rules to route packets. In many cases, static routes are manually configured on the router by a network administrator. For example, a network administrator may change or updates entries in the routing table of a router to implement static routing or to install the routing policy on the router. Static routing is in contrast to dynamic routing (a.k.a., adaptive routing), where a router determines current conditions or metrics within a domain using, for example, IGP and then performs routing based on the determined conditions or metrics. Unlike dynamic routing, static routes are fixed and do not change when the network is changed or reconfigured. Static routing and dynamic routing are not mutually exclusive. Both dynamic routing and static routing may be used on a router to maximize routing efficiency and to provide backups in case dynamic routing information fails to be exchanged.

In FIG. 6, each of the links 618 has a metric. For example, the link 618 between Router A and Router B has a metric of 10, the link 618 between Router B and Router C has a metric of 10, the link 618 between Router C and Router E has a metric of 10, the link 618 between Router A and Router D has a metric of 10, and the link 618 between Router D and Router E has metric of 10.

When Router A performs an SPF calculation based on the above metrics, Router A determines that the best path from Router A to Router E is Router A→Router D→Router E. This is because the total cost of the path from Router A to Router E via Router D, which is 20 (i.e., 10+10), is less than the total cost of the path from Router A to Router E via Router B and Router C, which is 30 (i.e., 10+10+10). However, due to the static routing on Router A, Router A does not install the routing path from Router A to Router E via Router B and Router C to the FIB table even though the cost of that path is the least. Moreover, Router R does not route packets along the path including Router B and Router C. Rather, Router A will route packets on the path of Router A→Router B→Router C→Router E in accordance with the static policy installed in the FIB table of Router A.

In an embodiment, Router A notifies the other routers in the network that Router A is using static routing, is subject to a routing policy that supersedes the SPF calculations, that an SPF calculated route has been replaced with a static route, that routing parameters determined according to SPF calculations have not been installed in the FIB of Router A, or some combination thereof. In an embodiment, the notification sent by Router A to the other routers in the network is an update message, an OSPF message, an IS-IS message, or some other type of routing message. As used herein, each of these messages may be referred to as a link state announcement.

An example of how to build the SAV table 604 from the perspective of Router E when a path through the IGP domain is based on static routing or a routing policy is provided. Notably, the same procedure may be similarly used by other routers in the domain to build their own SAV table.

To begin, Router E receives a link state announcement from one or more of the other network nodes in the IGP domain. That is, Router E receives a link state announcement from Router A, Router B, Router C, and/or Router D. In an embodiment, the link state announcement is an LSU corresponding to the OSPF protocol or an LSP corresponding to the IS-IS protocol. By way of example, assume that the link state announcement received from Router A specifies a static routing or a routing policy for routing packets from Router A to Router E.

Router E performs an SPF calculation based on the link state announcement received from the other network nodes to determine a path though the domain. Thereafter, Router E builds a FIB table based on the SPF calculation. The FIB build on Router E may be similar to the FIB 406, 506 of FIGS. 4-5. Therefore, a detailed explanation of that process is not repeated herein.

Next, Router E performs a second SPF calculation to account for the static routing or routing policy implemented at Router A and as reported by Router A in the link state announcement. In an embodiment, Router E performs the additional SPF calculation using a value of zero for the metric between Router A and Router B instead of the value of 10 as shown in FIG. 6. As illustrated in FIG. 6, Router B is the next hop of Router A.

Next, Router E generates the SAV table 604 based on the FIB table and the second SPF calculation. In an embodiment, the SAV table 604 includes entries for both Router C and Router D in the incoming port column so that packets received from either Router C or Router D are determined to be valid. In an embodiment, the entry in the incoming port column for Router C is Eth 1/0 (to C), and the entry in the incoming port column for Router D is Eth 1/1 (to D). Because the SAV table 604 does not identify a separate destination (or destination prefix) for each incoming port, the SAV table 604 may be referred to as a SAV table for router level encoding.

In an embodiment, Router E generates the SAV table 654 based on the FIB table and the second SPF calculation. In an embodiment, the SAV table 654 includes an entry for Router C in one row of the incoming port column, and an entry for Router D in another row of the incoming port column. As before, such entries ensure that packets received from either Router C or Router D are determined to be valid. However, the separate entries in the SAV table 654 permit each entry in the incoming port column to be associated with a particular destination (or group of destinations). For example, packet traffic intended for destination 192.168.1.0/24 will be routed from Router A to Router B and thus come in to Router E via Router C, while packet traffic intended for everything else (e.g., destination 192.168.2.0/24) will be routed from Router A to Router D and thus come in to Router E via Router D. Because the SAV table 654 identifies a separate destination (or destination prefix) for each incoming port, the SAV table 654 may be referred to as a SAV table for prefix level encoding.

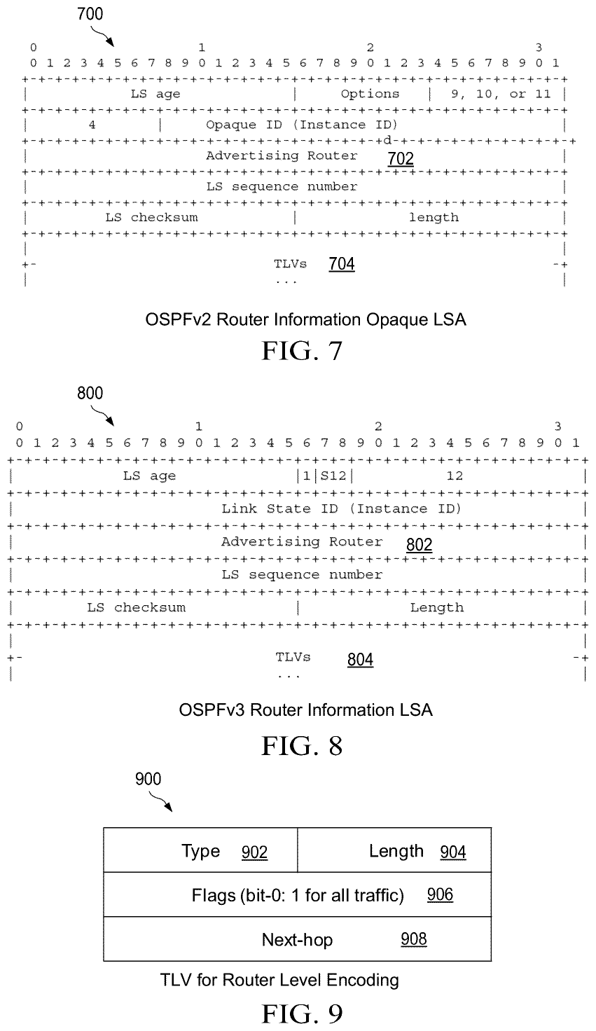

FIG. 7 is an OSPFv2 Router Information Opaque LSA 700 according to an embodiment of the disclosure. The OSPFv2 Router Information Opaque LSA 700 is described in detail in IETF RFC 7770 entitled “Extensions to OSPF for Advertising Optional Router Capabilities” by A. Lindem, et al., published February 2016.

As shown, the OSPFv2 Router Information Opaque LSA 700 includes an Advertising Router field 702 and a TLVs field 704. The Advertising Router field 702 includes a value indicating the router that sent the OSPFv2 Router Information Opaque LSA 700. For example, the Advertising Router field 702 may include a value to indicate that Router A sent the OSPFv2 Router Information Opaque LSA 700. The TLVs field 704 is configured to carry one or more TLVs, as will be more fully explained below.

FIG. 8 is an OSPFv3 Router Information LSA 800 according to an embodiment of the disclosure. The OSPFv3 Router Information LSA 800 is described in detail in IETF RFC 7770 entitled “Extensions to OSPF for Advertising Optional Router Capabilities” by A. Lindem, et al., published February 2016.

As shown, the OSPFv3 Router Information LSA 800 includes an Advertising Router field 802 and a TLVs field 804. The Advertising Router field 802 includes a value indicating the router that sent the OSPFv3 Router Information LSA 800. For example, the Advertising Router field 802 may include a value to indicate that Router A sent the OSPFv3 Router Information LSA 800. The TLVs field 804 is configured to carry one or more TLVs, as will be more fully explained below.

FIG. 9 is a TLV 900 for router level encoding according to an embodiment of the disclosure. The TLV 900 is configured to be included in the TLVs field 704, 804 in FIGS. 7-8. In an embodiment, the TLV 900 is used by a network node (e.g., Router A) to advertise the static policy or the routing policy of that network node.

As shown, the TLV 900 includes a type field 902, a length field 904, a flags field 906, and a next hop field 908. The type field 902 includes a value indicating that the TLV 900 is being used to communicate the static policy or the routing policy of the sending network node. The length field 904 includes a value that specifies a length of the TLV 900.

The flags field 906 includes a value that specifies whether traffic will be received from one network node or from different network nodes. For example, the first bit (e.g., bit-0) of the flags field 906 may be set to a first binary value (e.g., 0) to signify that traffic will be received from network nodes on multiple paths (e.g., the top arrow and the bottom arrow in FIG. 4). The first bit of the flags field 906 may be set to a second binary value (e.g., 1) to signify that traffic will be received from network nodes on a single path (e.g., the top arrow in FIG. 4).

The next hop field 908 includes a value that identifies a next hop of the network node that dispatched the TLV 900. For example, when Router A transmits the TLV 900, the next hop field includes a value to signify that Router B is the next hop on the backup path to Router E.

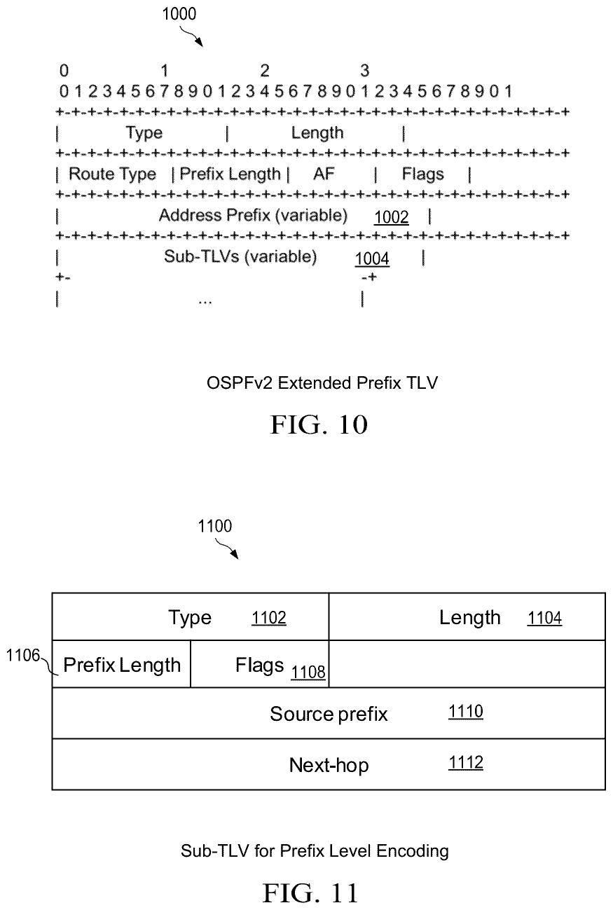

FIG. 10 is an OSPFv2 Extended Prefix TLV 1000 according to an embodiment of the disclosure. The OSPFv2 Extended Prefix TLV 1000 is described in detail in IETF RFC 7684 entitled “OSPFv2 Prefix/Link Attribute Advertisement” by P. Psenak, et al., published November 2015.

As shown, the OSPFv2 Extended Prefix TLV 1000 includes an Address Prefix field 1002 and a sub-TLVs field 1004. The Address Prefix field 1002 includes a value indicating a destination prefix (or destination) to be used by the receiving router when the receiving router builds a SAV table. For example, the Address Prefix field 1002 includes a value to indicate the destination prefix, e.g., the destination prefix 192.168.1.0/24 in FIG. 6. In an embodiment, the Address Prefix field 1002 has a variable length. The sub-TLVs field 1004 is configured to carry one or more sub-TLVs, as will be more fully explained below.

FIG. 11 is a sub-TLV 1100 for prefix level encoding according to an embodiment of the disclosure. The sub-TLV 1100 is configured to be included in the sub-TLVs field 1004 in FIG. 10. In an embodiment, the sub-TLV 1100 is used by a network node (e.g., Router A) to advertise the static policy or the routing policy of that network node.

As shown, the sub-TLV 1100 includes a type field 1102, a length field 1104, a prefix length field 1106, a flags field 1108, a source prefix field 1110, and a next hop field 1112. The type field 1102 includes a value indicating that the sub-TLV 1100 is being used to communicate the static policy or the routing policy of the sending network node. The length field 1104 includes a value that specifies a length of the sub-TLV 1100.

The prefix length field 1106 includes a value that specifies a value of a prefix, such as the source prefix in the source prefix field 1110. The flags field 1108 includes a value that specifies whether traffic will be received from one network node or from different network nodes. For example, the first bit (e.g., bit-0) of the flags field 1108 may be set to a first binary value (e.g., 0) to signify that traffic will be received from network nodes on multiple paths (e.g., the top arrow and the bottom arrow in FIG. 4). The first bit of the flags field 1108 may be set to a second binary value (e.g., 1) to signify that traffic will be received from network nodes on a single path (e.g., the top arrow in FIG. 4).

The source prefix field 1110 includes a value to indicate the source prefix, e.g., the source prefix 10.10.10.0/24 in FIG. 6. The next hop field 1112 includes a value that identifies a next hop of the network node that dispatched the sub-TLV 1100. For example, when Router A transmits the sub-TLV 1100, the next hop field includes a value to signify that Router B is the next hop.

As noted above, FIGS. 10-11 are used for OSPFv2. A similar process is used for OSPFv3. For OSPFv3, a Router-Link TLV may be used in place of the OSPFv2 Extended Prefix TLV 1000. The Router-Link TLV (not shown) may be used to carry the sub-TLV 1100. Thus, the encoding for OSPFv3 is similar to the encoding for OSPFv2.

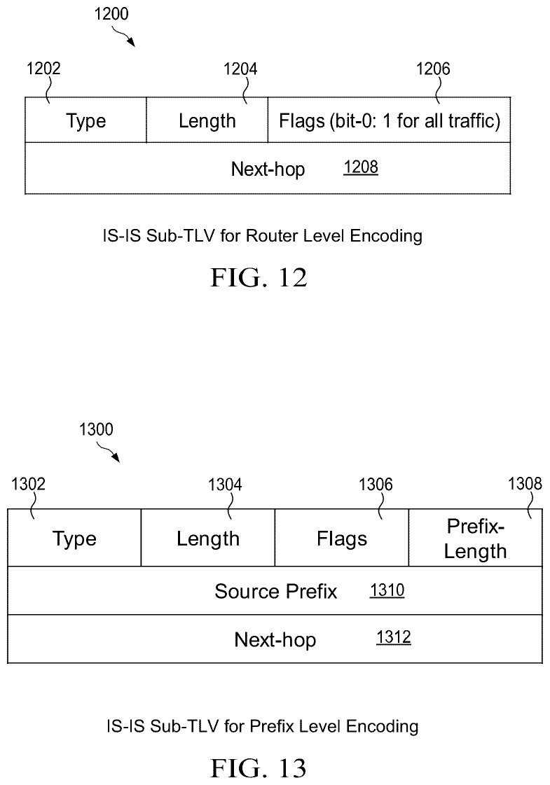

FIG. 12 is a schematic diagram of an IS-IS sub-TLV 1200 for router level encoding according to an embodiment of the disclosure. The IS-IS sub-TLV 1200 is configured to be included in an IS-IS Router Capability TLV (type 242) (not shown). In an embodiment, the IS-IS sub-TLV 1200 is used by a network node (e.g., Router A) to advertise the static policy or the routing policy of that network node.

As shown, the IS-IS sub-TLV 1200 includes a type field 1202, a length field 1204, a flags field 1206, and a next hop field 1208. The type field 1202 includes a value indicating that the IS-IS sub-TLV 1200 is being used to communicate the static policy or the routing policy of the sending network node. The length field 1204 includes a value that specifies a length of the IS-IS sub-TLV 1200.

The flags field 1206 includes a value that specifies whether traffic will be received from one network node or from different network nodes. For example, the first bit (e.g., bit-0) of the flags field 1206 may be set to a first binary value (e.g., 0) to signify that traffic will be received from network nodes on multiple paths (e.g., the top arrow and the bottom arrow in FIG. 4). The first bit of the flags field 1206 may be set to a second binary value (e.g., 1) to signify that traffic will be received from network nodes on a single path (e.g., the top arrow in FIG. 4).

The next hop field 1208 includes a value that identifies a next hop of the network note that dispatched the IS-IS sub-TLV 1200. For example, when Router A transmits the IS-IS sub-TLV 1200, the next hop field includes a value to signify that Router B is the next hop.

FIG. 13 is a schematic diagram of an IS-IS sub-TLV 1300 for prefix level encoding according to an embodiment of the disclosure. The IS-IS sub-TLV 1300 is configured to be included in an Extended IPv4 reachability TLV as described in IETF RFC 5305 entitled “IS-IS Extensions for Traffic Engineering” by T. Li, et al., published October 2008, a Multi-topology IPv4 Reachability TLV as described in IETF RFC 5120 entitled “M-ISIS: Multi Topology (MT) in Intermediate System to Intermediate Systems (IS-ISs)” by T. Przygienda, et al., published February 2008, an IPV6 IP Reachability TLV as described in IETF RFC 5308 entitled “Routing IPv6 with IS-IS” by C. Hopps, published October 2008, or a Multi-topology IPv6 Reachability TLV as described in IETF RFC 5120. In an embodiment, the IS-IS sub-TLV 1300 is used by a network node (e.g., Router A) to advertise the static policy or the routing policy of that network node.

As shown, the IS-IS sub-TLV 1300 includes a type field 1302, a length field 1304, a flags field 1306, a prefix length field 1308, a source prefix field 1310, and a next hop field 1312. The type field 1302 includes a value indicating that the sub-TLV 1300 is being used to communicate the static policy or the routing policy of the sending network node. The length field 1304 includes a value that specifies a length of the sub-TLV 1300.

The flags field 1306 includes a value that specifies whether traffic will be received from one network node or from different network nodes. For example, the first bit (e.g., bit-0) of the flags field 1306 may be set to a first binary value (e.g., 0) to signify that traffic will be received from network nodes on multiple paths (e.g., the top arrow and the bottom arrow in FIG. 4). The first bit of the flags field 1306 may be set to a second binary value (e.g., 1) to signify that traffic will be received from network nodes on a single path (e.g., the top arrow in FIG. 4). The prefix length field 1308 includes a value that specifies a value of a prefix, such as the source prefix in the source prefix field 1310.

The source prefix field 1310 includes a value to indicate the source prefix, e.g., the source prefix 10.10.10.0/24 in FIG. 6. The next hop field 1312 includes a value that identifies a next hop of the network node that dispatched the sub-TLV 1300. For example, when Router A transmits the sub-TLV 1300, the next hop field includes a value to signify that Router B is the next hop on the backup path to Router E.

The disclosed embodiment are compatible with a variety of different tunnels or overlay interfaces. For example, the disclosed embodiments are compatible with Generic Routing Encapsulation (GRE). GRE is a tunneling protocol that can encapsulate a wide variety of network layer protocols inside virtual point-to-point links or point-to-multipoint links over an Internet Protocol network. For the embodiments disclosed herein, an underlay path will follow the shortest path from Router A to Router E based on existing metrics, and no extra work is needed. Using GRE, packets from Router A to Router E are encapsulated with a source address and a destination address.

The disclosed embodiments are compatible with Multiprotocol Label Switching (MPLS). MPLS is a routing technique in telecommunications networks that directs data from one node to the next based on labels rather than network addresses. An MPLS traffic engineering (TE) tunnel will route packets from Router A→Router B→Router C→Router E, where Router B is the next hop of Router A. Because this is a label switched path based on existing metrics, no extra work is needed.

The disclosed embodiments are compatible with Segment Routing over IPv6 (SRv6). SRv6 is a next-generation IP bearer protocol that combines Segment Routing (SR) and IPV6. Utilizing existing IPv6 forwarding technology, SRv6 implements network programming through flexible IPv6 extension headers. For each segment encapsulation, the shortest path calculated by SPF is used based on existing metrics, and no extra work is needed.

In an embodiment, a link bundling interface may be used with the disclosed embodiments. Link bundling allows multiple point-to-point links to be grouped together into one logical link to provide higher bidirectional bandwidth, redundancy, and load balancing between two routers. A virtual interface is assigned to the bundled link. When such link bundling is used, all underlay physical interfaces and the logical layer 3 (L3) interface are added to the SAV table for easy validation.

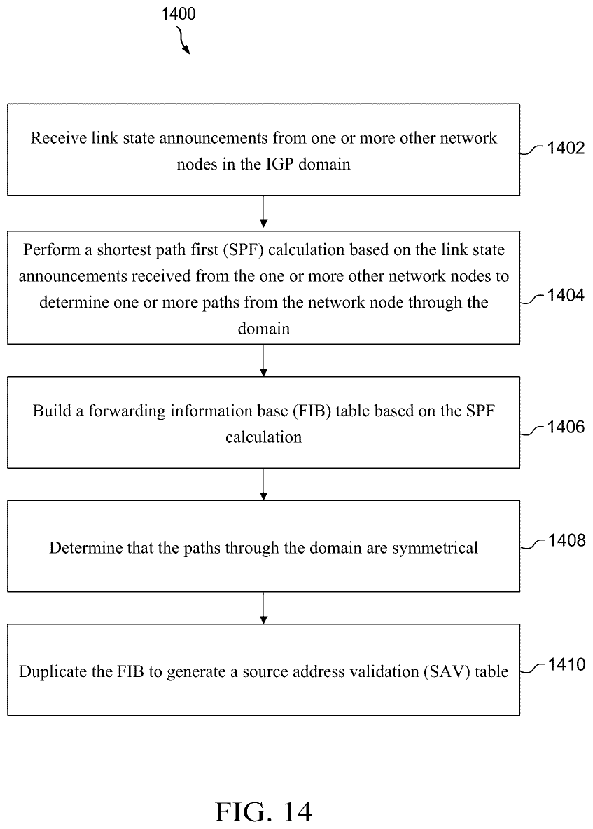

FIG. 14 is a method 1400 implemented by a network node in the IGP domain according to an embodiment of the disclosure. The method 1400 may be performed by a network node, such as Router A in FIG. 4, when there is symmetrical routing.

In block 1402, the network node receives link state announcements from one or more other network nodes in the IGP domain. In an embodiment, the network node is Router A, and the other network nodes are Routers B, C, D, and E.

In block 1404, the network node performs a shortest path first (SPF) calculation based on the link state announcements received from the one or more other network nodes to determine one or more paths from the network node through the domain. In block 1406, the network node builds a forwarding information base (FIB) table based on the SPF calculation. In block 1408, the network node determines that the paths through the domain are symmetrical. In block 1410, the network node duplicates the FIB table to generate a source address validation (SAV) table.

In an embodiment, the SAV table is built based on only IGP and not any additional protocol. For example, the SAV table is build based on IGP only, i.e., on OSPF or IS-IS protocols only, and not using any additional protocol such as the new protocol introduced or used in DSAV.

In an embodiment, the FIB table includes a destination prefix column and an outgoing port column, and the SAV table includes a source prefix column and an incoming port column. In an embodiment, values in the destination prefix column are identical to values in the source prefix column, and values in the outgoing port column are identical to values in the incoming port column.

In an embodiment, the method 1400 further comprises receiving a packet identifying a source address and a destination address, verifying that the packet was received on an incoming port corresponding to the source address using the SAV table, and transmitting the packet from an outgoing port corresponding to the destination address using the FIB table.

In an embodiment, the method 1400 further comprises receiving a packet identifying a source address and a destination address, determining that the packet was not received on an incoming port corresponding to the source address using the SAV table, and dropping the packet.

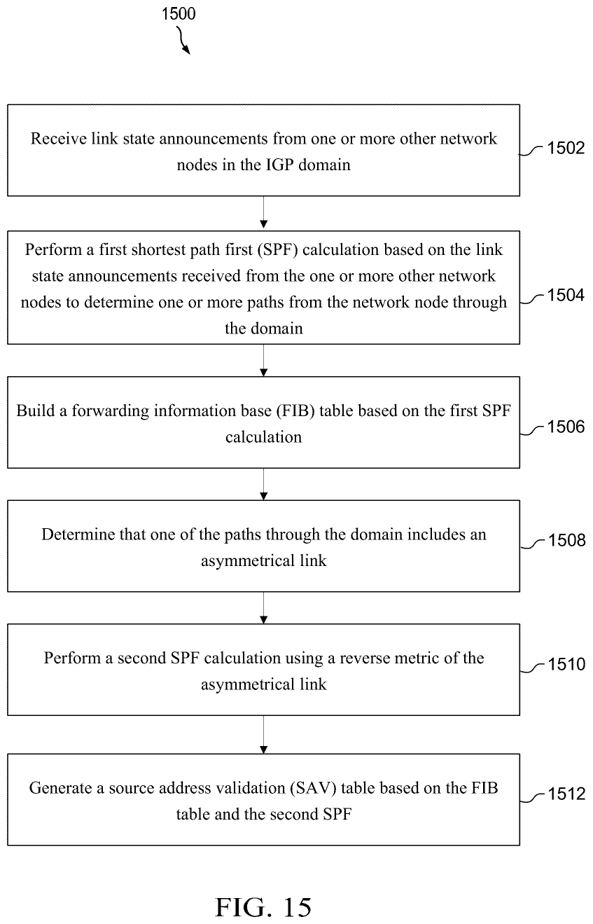

FIG. 15 is a method implemented by a network node in the IGP domain according to an embodiment of the disclosure. The method 1500 may be performed by a network node, such as Router A in FIG. 5, when there is asymmetrical routing.

In block 1502, the network node receives a link state announcement from one or more other network nodes in the IGP domain. In block 1504, the network node performs a first shortest path first (SPF) calculation based on the link state announcement received from the one or more other network nodes to determine a path from the network node through the domain. In block 1506, the network node builds a forwarding information base (FIB) table based on the first SPF calculation.

In block 1508, the network node determines that the path through the domain includes an asymmetrical link. In block 1510, the network node performs a second SPF calculation using a reverse metric of the asymmetrical link. In block 1512, the network node generates a source address validation (SAV) table based on the FIB and the second SPF calculation.

In an embodiment, link metrics, including the reverse link metric, are stored in a link state database (LSDB) of the network node. In an embodiment, the network node compares the link metrics in both forward and reverse directions during the first SPF calculation to determine the path through the domain includes the asymmetric link. In an embodiment, the network node compares the link metrics in both forward and reverse directions when receiving the link state announcement from the one or more other network nodes to determine the path through the domain includes the asymmetric link.

In an embodiment, the network node receives a message from the one or more other network nodes that a link connected to the one or more other network nodes is asymmetric. That is, one of the other network nodes detects the lack of symmetry and reports the same to the network node.

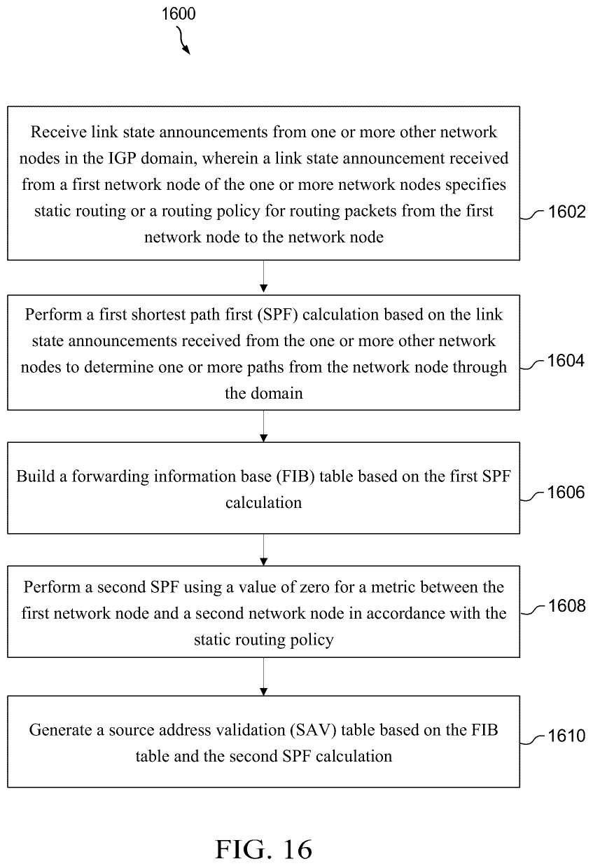

FIG. 16 is a method implemented by a network node in the IGP domain according to an embodiment of the disclosure. The method 1600 may be performed by a network node, such as Router E in FIG. 6, when a first network node, such as Router A, is subject to a routing policy or uses static routing.

In block 1602, the network node receives link state announcements from one or more other network nodes in the IGP domain. In an embodiment, a link state announcement received from a first network node of the one or more network nodes specifies static routing or a routing policy for routing packets from the first network node to the network node.

In block 1604, the network node performs a first shortest path first (SPF) calculation based on the link state announcement received from the one or more other network nodes to determine one or more paths from the network node through the domain. In block 1606, the network node builds a forwarding information base (FIB) table based on the first SPF calculation.

In block 1608, the network node performs a second SPF calculation using a value of zero for a metric between the first network node and a second network node in accordance with the static routing or the routing policy. In block 1610, the network node generates a source address validation (SAV) table based on the FIB and the second SPF calculation.

In an embodiment, the method further comprises determining that one of the paths through the domain includes an asymmetrical link, wherein the second SPF calculation is performed using a reverse metric of the asymmetrical link, and the value of zero for the metric between the first network node and the second network node in accordance with the static routing or the routing policy.

In an embodiment, the second network node is a next hop of the first network node. In an embodiment, the second network node is Router B in FIG. 6. In an embodiment, the SAV table includes a destination port corresponding to a source prefix.

In an embodiment, the link state announcement received from the first network node includes a type length value (TLV) field. In an embodiment, a TLV in the TLV field includes a flags field and a next hop field. In an embodiment, a value in the flags field is zero, and a value in the next hop field identifies the second network node. In an embodiment, the link state announcement is an Open Shortest Path First version 2 (OSPFv2) Router Information Opaque link state announcement or an Open Shortest Path First version 3 (OSPFv3) Router Information link state announcement.

In an embodiment, the link state announcement received from the first network node includes a type length value (TLV) field. In an embodiment, a TLV in the TLV field includes an address prefix field and a sub-type length value (TLV) field. In an embodiment, the address prefix field identifies a destination prefix, and a sub-TLV in the sub-TLV field includes a flags field, a source prefix field, and a next hop field. In an embodiment, a value in the flags field is one, a value in the source prefix field identifies a source, and a value in the next hop field identifies the second network node. In an embodiment, the link state announcement is an Extended Prefix Opaque link state announcement, and wherein the TLV is an Extended Prefix TLV or a Router-Link TLV.

In an embodiment, the link state announcement received from the first network node includes a type length value (TLV) field. In an embodiment, a TLV in the TLV field includes a sub-TLV field, and a sub-TLV in the sub-TLV field includes a flags field and a next hop field. In an embodiment, a value in the flags field is zero, and wherein a value in the next hop field identifies the second network node. In an embodiment, the TLV is an IS-IS Router Capability TLV.

In an embodiment, the link state announcement received from the first network node includes a type length value (TLV) field, and a TLV in the TLV field includes a sub-TLV field. In an embodiment, a sub-TLV in the sub-TLV field includes a flags field, a source prefix field, and a next hop field. In an embodiment, a value in the flags field is zero, a value in the source prefix field identifies a source, and a value in the next hop field identifies the second network node. In an embodiment, the TLV is an Extended Internet Protocol version 4 (IPv4) Reachability TLV, a Multi-Topology IPv4 Reachability TLV, an Internet Protocol version 6 (IPv6) Reachability TLV, or a Multi-Topology IPv6 Reachability TLV.

The disclosed embodiments offer advantages over existing technology. For example, the disclosed embodiments provide extensions to existing protocols to permit easy deployment, and make use of the existing information in routing protocols. The disclosed embodiments also resolve issues with existing RFP solutions, allow for easy deployment in IP networks, and function without having to upgrade network hardware. New encodings and algorithms may be used to achieve intra-domain source validation as disclosed herein.

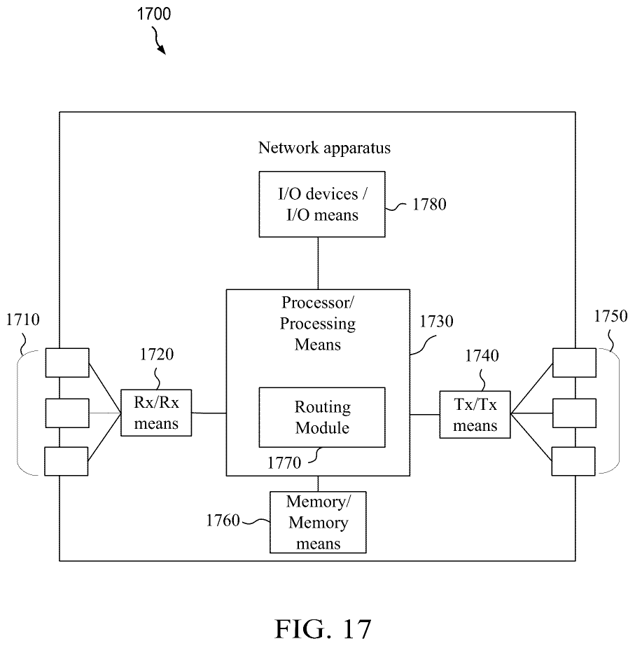

FIG. 17 is a schematic diagram of a network apparatus 1700 (e.g., a network node, a network router, a router, etc.). The network apparatus 1700 is suitable for implementing the disclosed embodiments as described herein. The network apparatus 1700 comprises ingress ports/ingress means 1710 (a.k.a., upstream ports) and receiver units (Rx)/receiving means 1720 for receiving data; a processor, logic unit, or central processing unit (CPU)/processing means 1730 to process the data; transmitter units (Tx)/transmitting means 1740 and egress ports/egress means 1750 (a.k.a., downstream ports) for transmitting the data; and a memory/memory means 1760 for storing the data. The network apparatus 1700 may also comprise optical-to-electrical (OE) components and electrical-to-optical (EO) components coupled to the ingress ports/ingress means 1710, the receiver units/receiving means 1720, the transmitter units/transmitting means 1740, and the egress ports/egress means 1750 for egress or ingress of optical or electrical signals.

The processor/processing means 1730 is implemented by hardware and software. The processor/processing means 1730 may be implemented as one or more CPU chips, cores (e.g., as a multi-core processor), field-programmable gate arrays (FPGAs), application specific integrated circuits (ASICs), and digital signal processors (DSPs). The processor/processing means 1730 is in communication with the ingress ports/ingress means 1710, receiver units/receiving means 1720, transmitter units/transmitting means 1740, egress ports/egress means 1750, and memory/memory means 1760. The processor/processing means 1730 comprises a routing module 1770. The routing module 1770 is able to implement the methods disclosed herein. The inclusion of the routing module 1770 therefore provides a substantial improvement to the functionality of the network apparatus 1700 and effects a transformation of the network apparatus 1700 to a different state. Alternatively, the routing module 1770 is implemented as instructions stored in the memory/memory means 1760 and executed by the processor/processing means 1730.

The network apparatus 1700 may also include input and/or output (I/O) devices or I/O means 1780 for communicating data to and from a user. The I/O devices or I/O means 1780 may include output devices such as a display for displaying video data, speakers for outputting audio data, etc. The I/O devices or I/O means 1780 may also include input devices, such as a keyboard, mouse, trackball, etc., and/or corresponding interfaces for interacting with such output devices.

The memory/memory means 1760 comprises one or more disks, tape drives, and solid-state drives and may be used as an over-flow data storage device, to store programs when such programs are selected for execution, and to store instructions and data that are read during program execution. The memory/memory means 1760 may be volatile and/or non-volatile and may be read-only memory (ROM), random access memory (RAM), ternary content-addressable memory (TCAM), and/or static random-access memory (SRAM).

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method implemented by a network node in an interior gateway protocol (IGP) domain, comprising:
receiving link state announcements from one or more other network nodes in the IGP domain;
performing a shortest path first (SPF) calculation based on the link state announcements received from the one or more other network nodes to determine one or more paths from the network node through the domain;
building a forwarding information base (FIB) table based on the SPF calculation;
determining that the paths through the domain are symmetrical; and
duplicating the FIB table to generate a source address validation (SAV) table.

2. The method of claim 1, wherein the SAV table is built based on only IGP and not any additional protocol.

3. The method of claim 1, wherein the FIB table includes a destination prefix column and an outgoing port column, and wherein the SAV table includes a source prefix column and an incoming port column.

4. The method of claim 3, wherein values in the destination prefix column are identical to values in the source prefix column, and wherein values in the outgoing port column are identical to values in the incoming port column.

5. The method of claim 1, further comprising:
receiving a packet identifying a source address and a destination address;
verifying that the packet was received on an incoming port corresponding to the source address using the SAV table; and
transmitting the packet from an outgoing port corresponding to the destination address using the FIB table.

6. The method of claim 1, further comprising:
receiving a packet identifying a source address and a destination address;
determining that the packet was not received on an incoming port corresponding to the source address using the SAV table; and
dropping the packet or transmitting the packet somewhere for further inspection.

7. A method implemented by a network node in an interior gateway protocol (IGP) domain, comprising:
receiving link state announcements from one or more other network nodes in the IGP domain;
performing a first shortest path first (SPF) calculation based on the link state announcement received from the one or more other network nodes to determine one or more paths from the network node through the domain;
building a forwarding information base (FIB) table based on the first SPF calculation;
determining that one of the paths through the domain includes an asymmetrical link;
performing a second SPF calculation using a reverse metric of the asymmetrical link; and
generating a source address validation (SAV) table based on the first SPF calculation and the second SPF calculation. 8 (New) The method of claim 7, wherein link metrics, including the reverse metric, are stored in a link state database (LSDB) of the network node.

9. The method of claim 7, further comprising comparing link metrics in both forward and reverse directions during the first SPF calculation to determine the path through the domain includes the asymmetric link.

10. The method of claim 7, further comprising comparing link metrics in both forward and reverse directions when receiving the link state announcement from the one or more other network nodes to determine the path through the domain includes the asymmetric link.

11. The method of claim 7, further comprising receiving a message from the one or more other network nodes that a link connected to the one or more other network nodes is asymmetric.

12. A method implemented by a network node in an interior gateway protocol (IGP) domain, comprising:
receiving link state announcements from one or more other network nodes in the IGP domain, wherein a link state announcement received from a first network node of the one or more network nodes specifies static routing or a routing policy for routing packets from the first network node to the network node;
performing a first shortest path first (SPF) calculation based on the link state announcements received from the one or more other network nodes to determine one or more paths from the network node through the domain;
building a forwarding information base (FIB) table based on the first SPF calculation;
performing a second SPF calculation using a value of zero for a metric between the first network node and a second network node in accordance with the static routing or the routing policy; and
generating a source address validation (SAV) table based on the FIB and the second SPF calculation.

13. The method of claim 12, further comprising determining that one of the paths through the domain includes an asymmetrical link, wherein the second SPF calculation is performed using:
a reverse metric of the asymmetrical link; and
the value of zero for the metric between the first network node and the second network node in accordance with the static routing or the routing policy.

14. The method of claim 12, wherein the second network node is a next hop of the first network node.

15. The method of claim 12, wherein the SAV table includes a destination port corresponding to a source prefix.

16. The method of claim 12, wherein the link state announcement received from the first network node includes a type length value (TLV) field, wherein a TLV in the TLV field includes a flags field and a next hop field, wherein a value in the flags field is zero, and wherein a value in the next hop field identifies the second network node.

17. The method of claim 16, wherein the link state announcement is an Open Shortest Path First version 2 (OSPFv2) Router Information Opaque link state announcement or an Open Shortest Path First version 3 (OSPFv3) Router Information link state announcement.

18. The method of claim 12, wherein the link state announcement received from the first network node includes a type length value (TLV) field, wherein a TLV in the TLV field includes an address prefix field and a sub-type length value (TLV) field, wherein the address prefix field identifies a destination prefix, wherein a sub-TLV in the sub-TLV field includes a flags field, a source prefix field, and a next hop field, wherein a value in the flags field is one, wherein a value in the source prefix field identifies a source, and wherein a value in the next hop field identifies the second network node.

19. The method of claim 18, wherein the TLV is an Intermediate System-Intermediate System (IS-IS) Router Capability TLV, or the TLV is an Extended Internet Protocol version 4 (IPv4) Reachability TLV, a Multi-Topology IPv4 Reachability TLV, an Internet Protocol version 6 (IPv6) Reachability TLV, or a Multi-Topology IPV6 Reachability TLV.

20. The method of claim 12, wherein the link state announcement received from the first network node includes a type length value (TLV) field, wherein a TLV in the TLV field includes a sub-TLV field, wherein a sub-TLV in the sub-TLV field includes a flags field and a next hop field, wherein a value in the flags field is zero, and wherein a value in the next hop field identifies the second network node, or the link state announcement received from the first network node includes a type length value (TLV) field, wherein a TLV in the TLV field includes a sub-TLV field, wherein a sub-TLV in the sub-TLV field includes a flags field, a source prefix field, and a next hop field, wherein a value in the flags field is zero, wherein a value in the source prefix field identifies a source, and wherein a value in the next hop field identifies the second network node, or the link state announcement is an Extended Prefix Opaque link state announcement, and wherein the TLV is an Extended Prefix TLV or a Router-Link TLV.
